(19) United States
(12) Patent Application Publication
(10) Pub. No.: US 2022/0140584 A1
(43) Pub. Date: May 5, 2022

(54) CABLE GUIDES FOR USE WITH CABLE TRAYS

(71) Applicant: James C. White Company, Inc., Greenville, SC (US)

(72) Inventor: Thomas C. White, Greenville, SC (US)

(21) Appl. No.: 17/579,236

(22) Filed: Jan. 19, 2022

Related U.S. Application Data
(63) Continuation-in-part of application No. 16/508,829, filed on Jul. 11, 2019, now Pat. No. 11,258,240.

(51) Int. Cl. H02G 3/04

(52) U.S. Cl. CPC H02G 3/0437; H02G 3/0456; H02G 3/0406

(57) ABSTRACT

A cable guide for use with a cable tray, a method for retaining cables using a cable guide, and a kit for retaining cables containing a cable guide that includes a cable guide with a base having a top portion, a bottom portion, a first end portion, a second end portion, two side portions parallel to each other, and a longitudinal axis. The two side portions extend longitudinally in a first direction along the longitudinal axis, wherein the first end portion is opposite the second end portion in the first direction and the two side portions extend between the first end portion to the second end portion. A slot is disposed within the base, and a sidewall extends upwardly from the first end portion of the base to an upper end. A flange extends outwardly from the upper end of the sidewall and parallel to the base having a top portion, a bottom portion, a first end portion, a second end portion, a first side portion, and a second side portion opposite the first side portion.

### CROSS REFERENCE TO RELATED APPLICATION

The present patent application/patent is a continuation-in-part of U.S. patent application Ser. No. 16/508,829 filed on Jul. 11, 2019 titled “CABLE GUIDES FOR USE WITH CABLE TRAYS”, the contents of which are incorporated in full by reference herein.

### FIELD

This disclosure relates generally to cables and flexible tubes in cable trays and, in particular, to cable guides for holding cables and tubes in cable trays.

### BACKGROUND

In manufacturing plants, for example, computer cables, optic fiber cables, buss cables, ethernet cables, data transmission cables, and other cables run from one part of a manufacturing plant to another. Cables are often elevated with respect to the plant floor so vehicles and workers moving across the plant floor are unimpeded, and the cables remain safely out of the way. The elevated cables are nonetheless accessible for replacement, rerouting, modification and maintenance. Cable trays are used to hold cables and tubes above the plant floor and to organize cables by their destinations so that they can be traced easily and maintained efficiently.

Cable maintenance may include adding new cables, removing cables that are no longer used, and replacing defective cables. Cable guides may be used to hold cables and tubes in place in the cable tray. A cable guide that makes it easier to add and remove cables and tubes from cable trays and also holds them securely, efficiently and properly in position, would be an advantage.

### SUMMARY

Briefly, and according to its major aspects, the present cable guide is a device for use with a cable tray and which facilitates the addition and removal of cables with respect to the cable tray and helps to hold cables in place in the cable tray. The cable guide includes a pair of opposing top surfaces or flanges extending partway across the opening of a cable tray. A first flange partially encloses the top opening of the cable tray from one sidewall of the cable tray toward the other sidewall, leaving space between the end of the flange and the opposing sidewall of the cable guide to provide access to the interior of the tray when adding a cable to, or removing a cable from, the tray. The diameter of the cable is able to pass between the end of the flange and the opposing sidewall. The second of the two opposing flanges, which is spaced axially apart from the first flange leaving a curved path for the insertion of the cable between the two flanges, extends from the second sidewall back across the tray toward the first sidewall, thereby partially enclosing the top opening with respect to the first cable guide to prevent a cable from falling out of the tray. The first flange and the second flange cooperate to define a curved path into the interior of the cable tray for a cable and simultaneously present an obstacle that tends to keep cables in place in the cable tray.

The cable guide may be made as one piece, with two opposing, spaced apart flanges, or as two separate pieces that are used as a pair, with one flange, to be spaced and otherwise positioned with respect to the other by a distance suitable for the stiffness and thickness of the particular cable being added or removed, that is, a little farther apart for a larger or stiffer cable and a little closer for a thinner or more flexible cable. Moreover, the separation between two adjacent cable guides depends on the flexibility of the flanges and the cable. The length of a cable guide flange depends on the width of the cable tray and the diameter of the cable that is to be inserted between the end of the guide flange and the opposing wall.

Whether as a pair of single cable guides or as a double cable guides, cable guides may be fastened to the cable tray—either to the interior of the cable tray or to the exterior of the cable tray—using fasteners.

It is an object of the present invention to have single cable guides that can be securely installed within a cable tray quickly without otherwise retaining the cables during installation. The single cable guides are preferably installed in sets of two along a cable tray or tray system, wherein the single cable guides within a set are installed within a cable tray in opposite directions or oriented on opposed sides of a cable tray. The single cable guides are installed in the cable tray in a spaced-apart arrangement, so that they have opposed gaps, meaning a gap is formed between its flange and a wall of the cable tray and each single cable guide forms a gap between its respective flange and an opposite wall from each other. The combination of the two single cable guides within the cable tray or tray system retain cables within the sable tray while installation is ongoing and generally after installation of the cable without reducing the width of the gaps through which the cables are inserted into the tray. Alternatively, the single cable guides within a set may installed within a cable tray facing the same direction or oriented on the same side of a cable tray and a gap may be formed between the flange of each single cable guide and the same wall of the cable tray.

It is another object of the invention for a method retaining cables within a cable tray with a single cable guide and a kit for retaining cables.

### BRIEF DESCRIPTION OF THE DRAWINGS

In the figures,

FIG. 1 is a perspective view of a double cable guide, according to an aspect of the disclosure;

FIG. 2 is a top view of the double cable guide of FIG. 1, according to an aspect of the disclosure;

FIG. 3 is a perspective view of a cable tray with two double cable guides that are holding two cables, according to an aspect of the disclosure;

FIG. 4 is a perspective view of two single cable guides, according to an aspect of the disclosure;

FIG. 5 is a perspective view of a cable tray with two pairs of single cable guides used with a cable tray, according to an aspect of the disclosure;

FIG. 6 is a perspective view of a narrow cable tray with two double cable guides, according to an aspect of the disclosure;

FIG. 7 is a perspective view of a wide cable tray with two single cable guides installed on the outside of the wide cable tray, one pair of single cable guides with closer cable guide spacing and the other with greater cable guide spacing, according to an aspect of the disclosure; and

FIG. 8 is a perspective view of a short cable tray with two single cable guides installed on the same side of the exterior of the cable tray, according to an aspect of the disclosure;

FIG. 9 shows a cable tray with two double cable guide attached to the outside of the cable tray, according to an aspect of the disclosure;

FIG. 10 is a wider cable tray with three double cable guides installed in an axially staggered sequence, including a double cable guide holding two cables, according to an aspect of the disclosure;

FIG. 11 is a wider cable tray with six double cable guides installed as three sets of two cable guides with a set of the three sets of two double cable guides holding two cables, according to an aspect of the disclosure;

FIG. 12 is a wider cable tray with 12 single cable guides, the single cable guides arranged in two groups of three pairs of two opposing cable guides, according to an aspect of the disclosure;

FIG. 13 is a perspective view of single cable guides of the present invention;

FIG. 14A is a perspective view of single cable guides of the present invention within a cable tray;

FIG. 14B is a perspective view of single cable guides of the present invention within a cable tray sliding along the cable tray; and

FIG. 15 is a perspective view of single cable guides of the present invention within a cable tray with cables being inserted within the cable tray.

### DETAILED DESCRIPTION

In this description, for convenience and for simplifying the description of the disclosure, the term cable will be used to mean cables and flexible tubes, unless otherwise stated. The term cable tray will be used to include cable trays and tube trays or tube tracks. The term “cable guide” will be used to refer to “cable guide,” “double cable guide” and “tube guide.”

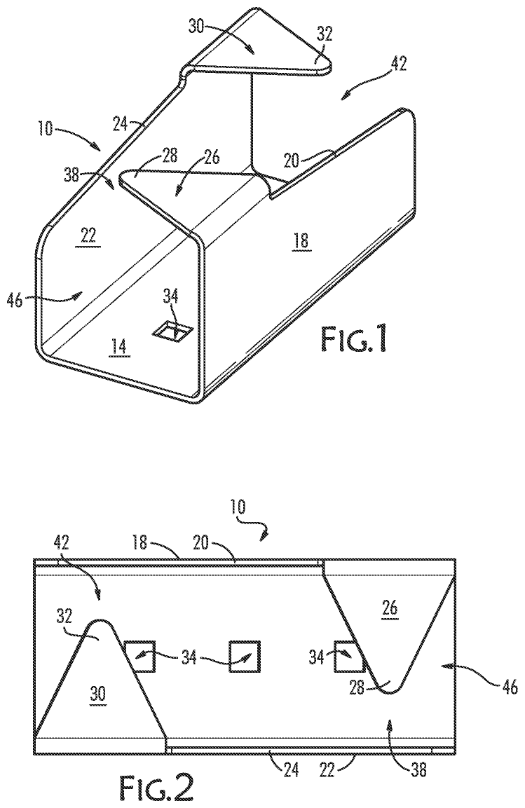

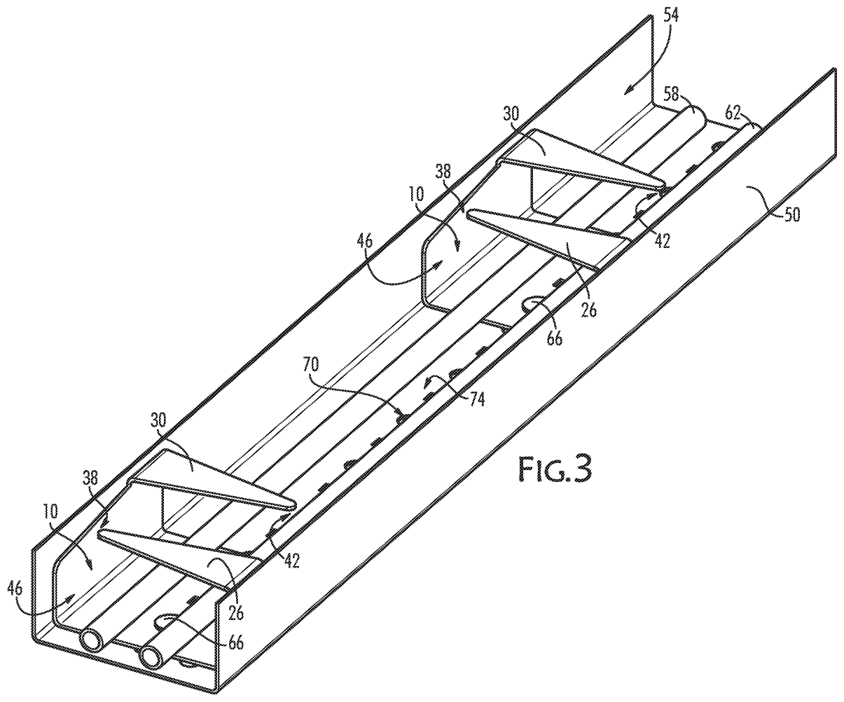

Referring now to the drawings, FIGS. 1 and 2 show a perspective view and top view, respectively, of a double cable guide 10. Double cable guide 10 includes a base 14, a first wall 18, and a second wall 22 spaced apart from first wall 18. Double cable guide 10 also includes a first flange 26 attached to and cantilevered from first wall 18 and a second flange 30 attached to and cantilevered from second wall 22. First flange 26 interleaves with second flange 30.

Base 14 of double cable guide 10 may have a hole 34 formed in it, as best seen in FIG. 2. Hole 34 may be a square hole (as shown), a round hole, a slot, or other shape.

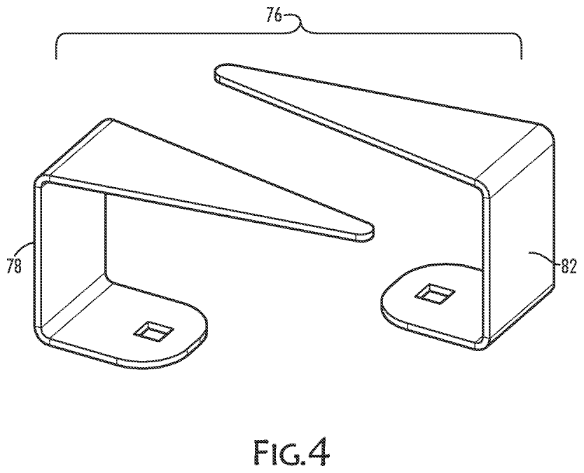

First wall 18 and second wall 22 of double cable guide 10 may be parallel to the other and perpendicular to base 14. First wall 18 and second wall 22 may be the height of a cable tray 50 (as best seen in FIG. 3) so that a cable tray cover (not shown) can be used to cover cable tray 50 when holding double cable guides 10 without interference.

First wall 18 and second wall 22 of double cable guide 10 have top edge 20 and top edge 24, respectively. First wall 18 and second wall 22 may be tapered, that is, first wall 18 and second wall 22 may be higher above base 14 starting at first flange 26 and second flange 30, respectively, and tapered to be gradually lower above base 14 farther from first flange 26 and second flange 30, for reasons that will be explained presently.

First flange 26 and second flange 30 extend generally parallel over base 14 in opposing directions, with first flange 26 extending horizontally toward second wall 22 and second flange 30 extending horizontally toward first wall 18, respectively, neither extending to touch the opposing wall. A first gap 38 remains between first flange 26 and second wall 22, and a second gap 42 remains between second flange 30 and first wall 18. First gap 38 and second gap 42 are made wide enough to pass a cable (not shown) having a diameter approximately the size of first gap 38 and second gap 42.

That first gap 38 and second gap 42 are on opposing sides of cable guide 10 is a feature of the disclosure. First flange 26 helps to guide a cable toward first gap 38, and second flange 30 helps to guide a cable toward second gap 42, and first flange 26 and second flange 30 help to keep a cable within a cable guide once the cable passes through first gap 38 and second gap 42, and is in place, as described more fully below. Cable clamps or other temporary cable installation devices are not used with single or double cable guides formed according to the present disclosure.

Note that the taper of first wall 18 and second wall 22, as noted above, results in a first gap 38 and second gap 42 that are slightly larger than that obtained had first wall 18 and second wall 22 not been tapered. The reason first gap 38 and second gap 42 are slightly larger is because they are the hypotenuses of two right triangles. First gap 38 and second gap 42 provide slightly more room for a cable to be inserted when inserted on a slight angle from vertical between first flange 26 and second wall 22, and between second flange 30 and first wall 18.

First flange 26 and second flange 30 are integrally formed with first wall 18 and second wall 22, respectively, and they define tapered horizontal cantilevers extending from first wall 18 and second wall 22, respectively. An end 28 of first flange 26 and an end 32 of second flange 30 may also be curved ends. The contoured, tapered sides and curved edges and ends of first flange 26 and second flange 30 reduce friction and avoid damage to cables as they are being installed into double cable guide 10. First flange 26 and second flange 30 also provide approach angles from either side to urge cables to slide into cable guide and toward first gap 38 and second gap 42, respectively, of double cable guide 10 and also enable the distance between first flange 26 and second flange 30 to be smaller by their facilitation of the maneuvering of a cable around first flange 26 and second flange 30 and into cable tray 50 (see FIG. 3).

Double cable guide 10 may be made of metal, metal alloy, structural plastic, or composite, and may be resilient so that first flange 26 and second flange 30 are able to bend up or down in accommodating a cable passing into interior 46 of double cable guide 10 through first gap 38 or second gap 42. When first flange 26 and second flange 30 flex, they bend resiliently to facilitate that insertion. Moreover, the tapering of the edges of first flange 26 and second flange 30 reduce the extent of the deflection of ends 28, 32, of first flange 26 and second flange 30, respectively, for the cable to pass into or out of cable guide 10.

FIG. 3 shows a cable tray 50 having an interior 54 into which two identical double cable guides 10 have been inserted. The same reference numbers used in FIG. 1 for double cable guide 10 are used for double cable guides 10 shown in FIG. 3. Double cable guides 10 are shown spaced apart. Two cables 58, 62 are shown in the interior 54 of cable tray 50 and in the interiors 46 of double cable guides 10. Double cable guides 10 span the width of interior 54 of cable tray 50. First flange 26 and second flange 30 of double cable guide 10 leave first gap 38 and second gap 42 that will enable insertion or removal of at least one of cables 58, 62, and for insertion of additional cables without disturbing the integrity of the respective positions of cables 58, 62.

Cable 58, for example, is guided into interior 54 through first gap 38 so it passes around and under first flange 26 while cable 58 is still above second flange 30, and then cable 58 can pass around second flange 30 into second gap 42 and under second flange 30 into interior 46 of double cable guide 10.

Double cable guides 10 shown in FIG. 3 are clamp to cable tray 50 using fasteners, such as low-head fasteners 66 through holes 70 in a floor 74 of cable tray 50. Other fasteners and securing means may be used, such as machine bolts with nuts, carriage bolts with nuts, rivets, snap-in pins, adhesives, and weldments.

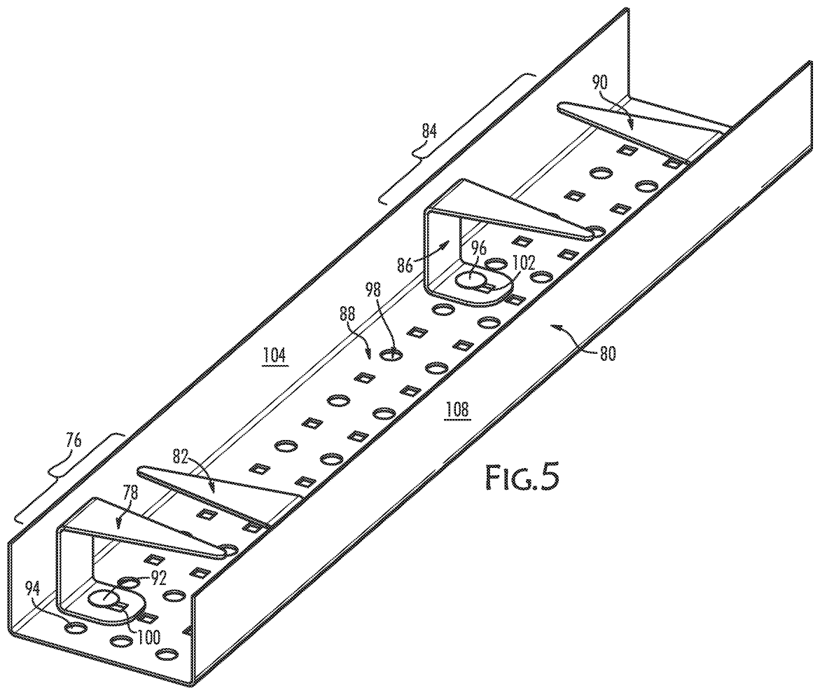

FIG. 4 illustrates a first pair 76 of single cable guides 78, 82, in perspective, and FIG. 5 illustrates first pair 76 of single cable guides 78, 82, and a second pair 84 of single cable guides, 86, 90, in a cable tray 80. Cable tray 80 has a floor 88. Single cable guides 78, 82, may also be made of metal or structural plastics.

Single cable guides 78, 82, of first pair 76 have a different spacing than that of single cable guides 86, 90 of second pair 84, which illustrates an advantage of single cable guides 78, 82, compared to double cable guide 10, namely, flexibility in spacing single cable guide 78, 82. A disadvantage of single cable guides 78, 82, compared to double cable guides 10 is the need to fasten single cable guide 78, 82, to floor 88 individually rather than to use one fastener to secure one double cable guide 10 to floor 74 (as shown in FIG. 3 and FIG. 5), which slows installation. Single cable guides of first pair 76 in FIG. 4 have an advantage when regulating cable tray curves and fittings that intersect with other cable trays.

Single cable guides 78, 82, may be attached to cable tray 80 using fasteners such as bolts 92, 96, inserted into holes 94, 98, in floor 88 of cable tray 80 for single cable guides 78, 82, and then tightening bolts 92, 96. Single cable guides 78, 82, may have slots 100, 102, as shown, to allow single cable guides 78, 82, to be positioned a little more or a little less closer to walls 104, 108.

Hole 94 may be round or square or a slot or a combination or in an alternating pattern, as shown in FIG. 5. Single cable guides 78, 82, and 86 and 90, may have slots 100, 102, to receive bolts 92, 96. Slots 100, 102 enable single cable guides to be moved in the long direction of slots 100, 102, which may, as shown in the example of FIG. 5, be perpendicular to the long dimension of cable tray 80.

Cable tray 80 has a first wall 104 and an opposing second wall 108. Single cable guides 78, 82 may thus be positioned away from first wall 104 and from second wall 108, respectively, using slots 100, 102, so cables held by cable guides 78, 82 may be advantageously positioned within cable tray 80, for example, against cable tray walls or to adjust gap widths.

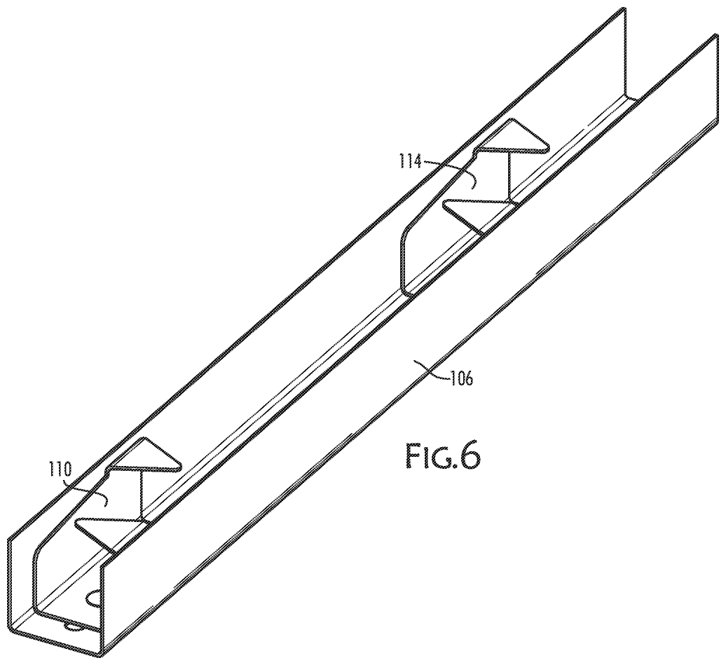

Cable trays vary in width; some are relatively narrow and some are wider. FIG. 6, for example, shows a narrow cable tray 106 with two double cable guides, 110, 114, respectively, therein.

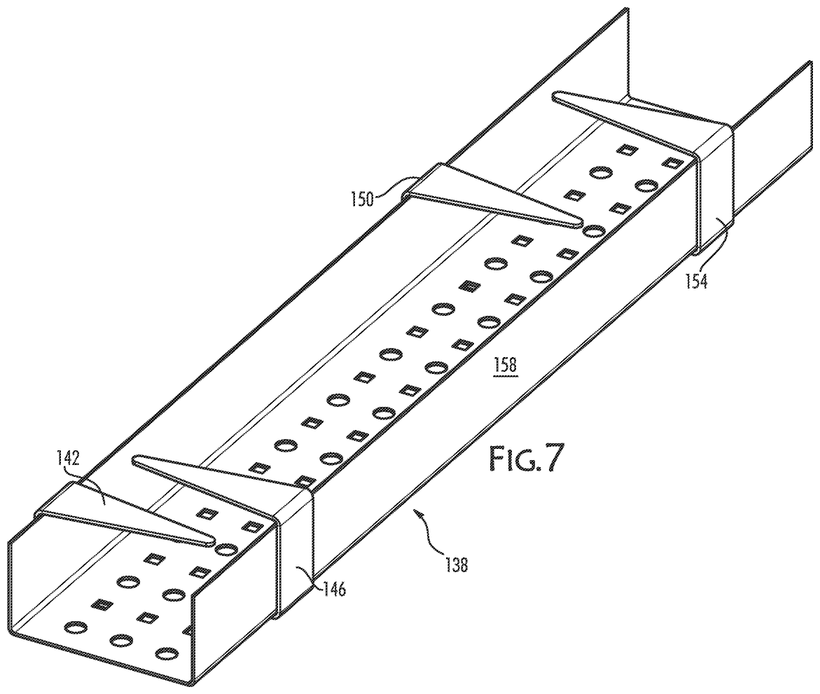

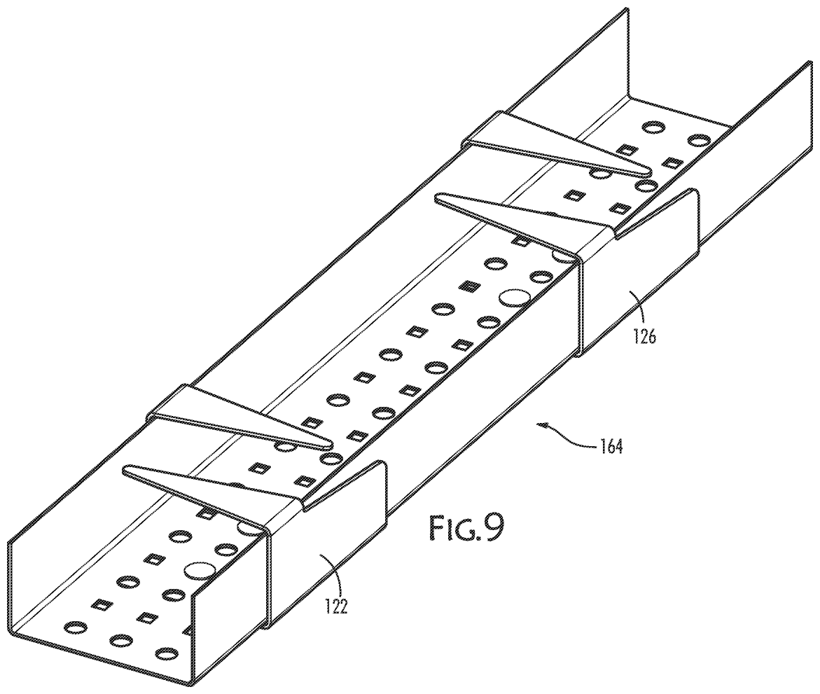

FIG. 7 depicts a wide cable tray 138 with a first pair of single cable guides 142, 146 and a second pair of single cable guides 150, 154, that are attached to the exterior surface 158 of cable tray 138. Whereas pairs of single cable guides are shown inserted into the interior of cable tray 106 in FIG. 6, single cable guides 142, 146, 150, and 154 can be slid over the exterior surface 158 in FIG. 7. An advantage of cable guides 142, 146, 150 and 154 on the exterior surface 158 of cable tray 138 is the increase in capacity of cable tray 138 that results. An advantage of single cable guides 142, 146, 150, 154, over double cable guides 122, 126, as seen in FIG. 9, is that they can be attached directly to exterior surface 158; double cable guides 168,172, would be placed onto the end of cable tray 164 and slid into position. A disadvantage of exterior cable guides 142, 146, 150, 154, over interior cable guides as shown in FIG. 5, is that a standard cable tray cover cannot be installed after completion of cable loading; custom-made tray covers may be required.

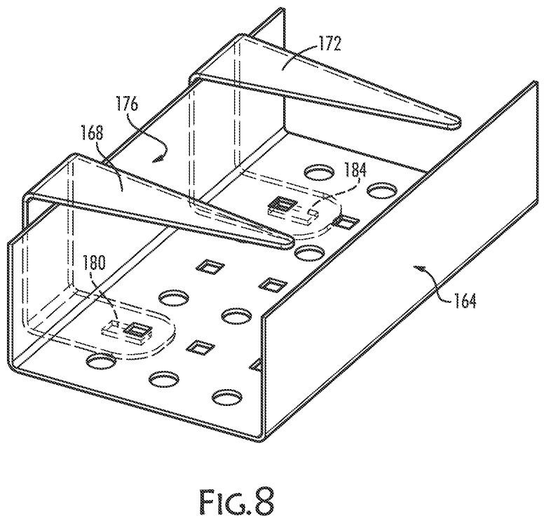

FIG. 8 illustrates a portion of a cable tray 164 with two single cable guides 168, 172, attached to the exterior of a first side 176 of cable tray 164. The single cable guides 168, 172 are partially hidden by cable tray 164 and those hidden parts are shown in phantom lines. Cable guides 168, 172, have slots 180, 184 that enable, as seen in FIG. 8, cable guide 168 to be slid away from cable tray 164 and cable guide 172 to be slid toward engagement with cable tray 164.

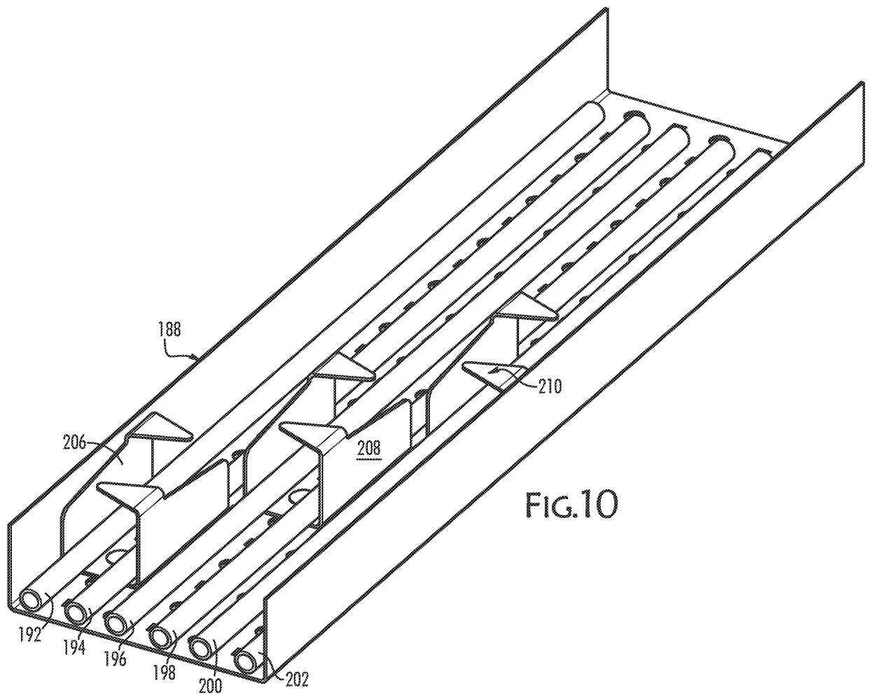

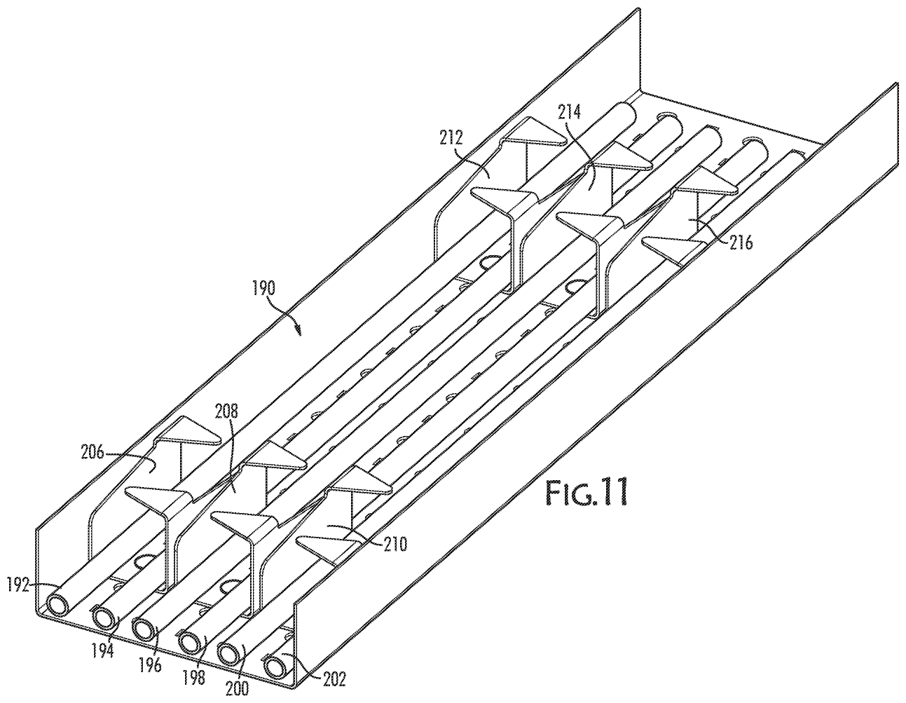

FIGS. 10 and 11 show two examples of a wider cable tray 188 having six cables 192, 194, 196, 198, 200, 202. In FIG. 10, three double cable guides 206, 208, 210 are positioned to be axially and laterally displaced from the other in cable tray 188. Double cable guide 206 holds cables 192 and 194 in cable guide 206; double cable guide 208 holds cables 196 and 198; and double cable guide 210 holds cables 200 and 202.

In FIG. 11, cable tray 190 also has six double cables guides 206, 208, 210, 212, 214, and 216, as seen in FIG. 10. However, three additional double cable guides 212, 214, and 216 have been added to double cable guides 206, 208 and 210. Also double cable guides 206, 208, and 210 are not staggered but aligned, as are the additional double cable guides 212, 214, 216, illustrating a different arrangement for using double cable guides. Cable guide spacings are a matter of discretion for the installer or the manufacturer of cable trays and various factors of the particular installation of cable tray and its cables.

Thus, in FIG. 11, cable guides 206, 208, 210, 212, 214, and 216 may serve an additional function beyond that of holding cables 192, 194, 196, 198, 200, and 202 in cable tray 188 or 190, namely, maintaining the integrity of the cable loading by enabling the user to grouping cables along the length of a cable tray 190. When cables are loaded, they may be loaded in a particular order to integrate cables running to the same location or otherwise related in some functional way. Accordingly, keeping related cables together and preserving the integrity of these cables' relative positions with respect to the other, assures that the related cables reach their common destinations, and also helps the user in tracing cables from origin to destination and accounting for all related cables.

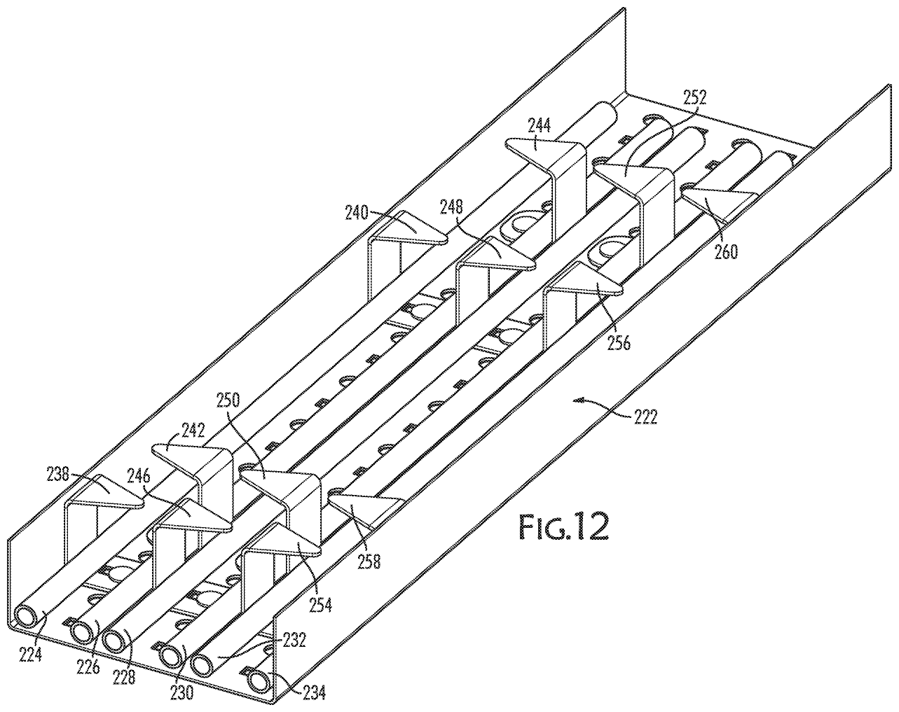

In a similar pattern, shown in FIG. 12, single cable guides can be installed to simulate the cable separation assembly of the double cable guide shown in FIG. 11. by arranging two opposing single cable guides in two groups of three pairs of single cable guides.

Specifically, cable tray 222 is wider, as is cable tray 188, and holds cable 224, cable 226, cable 228, cable 230, cable 232, and cable 234. Twelve single cable guides are divided into six pair of two opposing single cable guides. Each pair of opposing single cable guides acting in the manner of a double cable guide as shown in FIG. 11. Opposing single cable guides 238, 242 and 240, 244 hold cable 224, 226. Opposing single cable guides 246, 250 and 248, 252 hold cables 228, 230. Opposing single cables guides 254, 258 and 256, 260 hold cables 232,234.

Those familiar with cable tray use and cable maintenance will appreciate the many advantages of the present single and double cable guides from the foregoing description, including such minor modifications and substitutions thereto that do not depart from the spirit and scope of the disclosure.

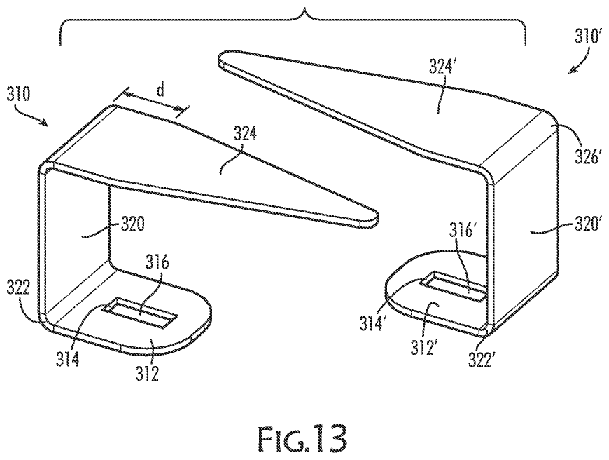

As shown in FIG. 13, the single cable guide 310 of the present invention contains a base 312 with a top portion, a bottom portion, a first end portion and a second end portion. The base 312 has a longitudinal axis and contains two side portions parallel to each other and extending longitudinally in a first direction along the longitudinal axis of the base 312. The first end portion is opposite the second end portion in the first direction and the two side portions extend between the first end portion to the second end portion. The first end portion is perpendicular to the two side portions and the second end portion has an arcuate shape extending from one side portion to the opposed side portion. A slot 314 is disposed within the base 312 of each single cable guide 310 with a slot opening 316 partially extending along the longitudinal axis of the base 312.

The slot 314 includes a pair of sides opposed to each other and a pair of opposed end portions, wherein the opposed end portions are in a perpendicular relationship with the pair of sides and the sides intersect the end portions defining corners and collectively defining a slot opening 316. The slot opening 316 extends from the top portion to the bottom portion of the base 312 and the bottom portion of the base 312 is adapted to be coupled to an adjacent cable tray 380. A fastener 318 is received within the slot 314. The fastener 318 may be a low-head fastener that can be inserted through holes 382 in a base 384 of a cable tray 380. The fastener 318 may be a bolt manufactured and sold by James C. White Company, Inc. (Greenville, S.C.) under the tradename “tubing bolt” that may be used with a locking flange nut (also available from James C. White Company, Inc. Greenville, S.C.) that is internally threaded and corresponds with the external threads of the “tubing bolt.” The “tubing bolt” may be used with or without a washer under the locking flange nut or between the base 384 of the cable tray 380 and the locking flange nut. The “tubing bolt” has the appearance of a short carriage bolt, except that the square structure under the bolt head is coaxial with the threaded portion and shorter than an American Standard carriage bolt to fit within the thickness of the base 384 of the cable tray 380 and being secured. The square structure under the bolt head is designed to be received within a square shaped hole 382 on the base 384 of the cable tray 380, allowing the “tubing bolt” to be secured to the base 384 of the cable tray 380 by only securing the locking flange nut. In other words, the user rotates the locking flange nut along the external threads of the “tubing bolt,” while the head of the “tubing bolt” is stationary because the square structure under the bolt head is received within a square hole 382 of the base 384 of the cable tray 380 and does not rotate as the locking nut is rotated along the length of its external threads. Other fasteners and securing means may be used, such as machine bolts with nuts, carriage bolts with nuts, rivets, and snap-in pins. The fastener 318 is intended to secure the single cable guide 310 into a desired position on the cable tray 380 and restrict movement of the single cable guide 310 except when the fastener 318 is loosened or removed for positioning the single cable guide 310. During use, the single cable guides 310 are secured to the cable tray 380 during loading and unloading, such as inserting a cable 328 or cables 328 into the cable tray 380 and removing a cable 328 or cables 328 from the cable tray 380, and after installation is complete.

A sidewall 320 extends upwardly from the first end portion of the base 312, wherein the transition 322 of the sidewall 320 and base 312 is curved without an edge or sharp point along the surface of the sidewall 320 or base 312. The sidewall 320 is generally perpendicular to the base 312 and extends upward to an upper end and contains two opposed side portions parallel to each other, meaning the sidewall 320 has a constant width. The sidewall 320 is integrally formed with the base 312. A flange 324 extends outwardly from the upper end of the sidewall 320 over top the base 312 and generally parallel with the base 312. The length of the flange 324 is generally greater than the length of the base 312 and preferably slightly less than the width of the cable tray 380 to which it is coupled. The transition of the upper end of the sidewall 320 and flange 324 is curved without an edge or sharp point along the surface of the sidewall 320 or flange 324. The flange 324 is integrally formed with the sidewall 320.

The flange 324 has a top portion, a bottom portion, a first end portion, and a second end portion. The flange 324 has a longitudinal axis with a first direction and contains two side portions. The two side portions extend longitudinally in a first direction from the first end portion to a distance “d” and parallel to each other, wherein the width between each side portion in the axial direction of the flange 324 is constant along distance “d”. Thereafter, the two side portions begin to converge towards the longitudinal axis of the flange 324. The two side portion begin to converge towards each other after extending along the predetermined distance “d” towards each other as they extend in the first direction along the longitudinal axis towards the second end portion. The second end portion is a curved end and connects the two side portions and does not contain a sharp edge or point. Furthermore, the transition at distance “d” is chamfered and does not contain a sharp edge or point. The curved end, chamfered side portions, and curved transition of the single cable guide 310 reduces friction and avoids damage to cables 328 as they are placed within a cable tray 380 that the single cable guide 310 is coupled. The shape of the flange 324 provides approach angles from each side of the flange 324 to urge cables 328 to slide around the flange 324 into the cable tray 380, as shown in FIG. 15.

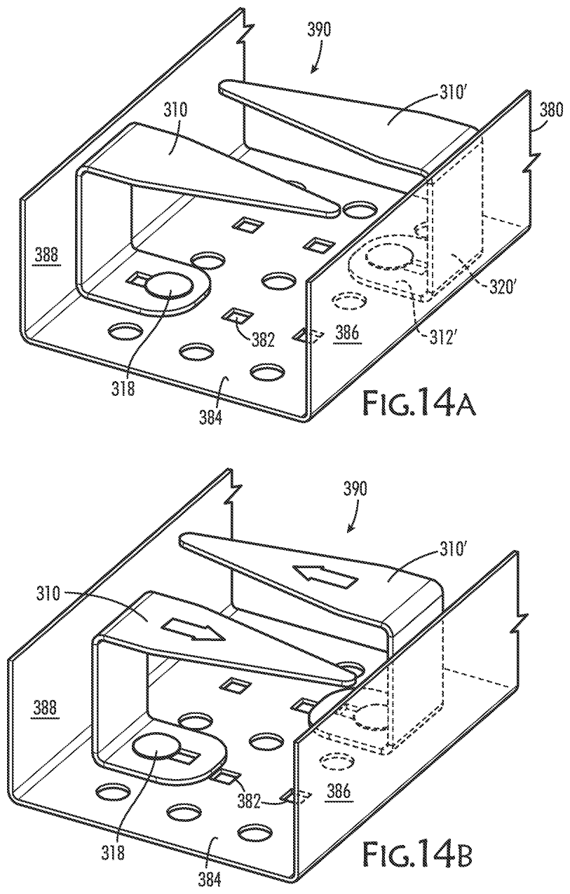

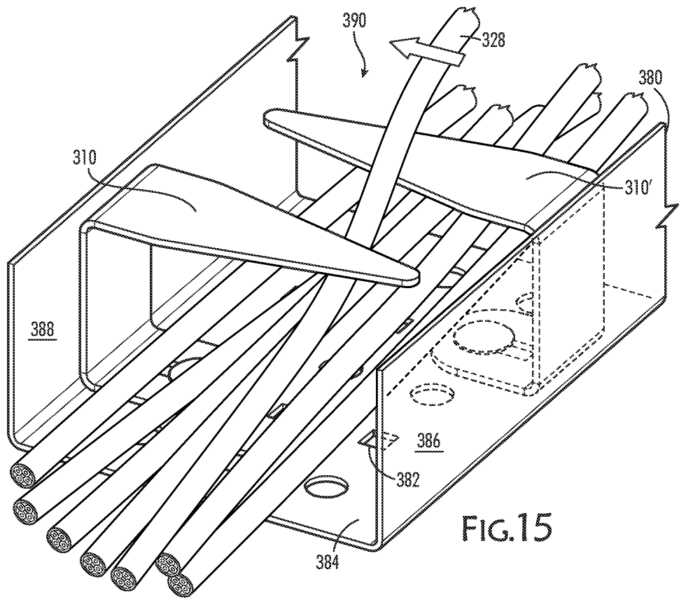

As shown in the FIGS. 14A and 14B, the height of the single cable guide 310 may be the height of a cable tray 380 so that a cable tray cover (not shown) can be used to cover the cable tray 380 without interference.

The single cable guide 310 may be made of metal, metal alloy, structural plastic, or composite and may be resilient so that the flange 324 is able to bend up or down in accommodating a cable 328 passing around the flange 324 and into the cable tray 380. When the flange 324 flexes, it bends resiliently to facilitate the insertion of the cable 328 into the cable tray 380.

As illustrated in FIG. 13, the base of the single cable guide 310 contains a slot 314, preferably centrally located on the base 312. The fastener 318 is received within the slot opening 316 of the slot 314, extending through a hole 382 in the base 384 of the cable tray 380. The hole 382 within the base 384 of the cable tray 380 may be circular or square, as illustrated in FIGS. 14A and 14B, or other geometric shape. The hole 382 may also be a bore, field drilled hole, or other opening within the base 384 of the cable tray 380 extending from the top surface to the bottom surface of the base 384 of the cable tray 380. The slot 314 in the base 312 of the single cable guide 310 allows the single cable guide 310 to be moved in the long direction of the slot opening 316 of the slot 314, which may, as shown in FIGS. 14A and 14B, be perpendicular to the long dimension of the cable tray 380 or in the axial direction of the cable tray. The slot 314 in the base 312 of the single cable guide 310 allows the single cable guide 310 to move or slid along the top surface of the base 384 of the cable tray 380 until the fastener 318 is tightened to secure the single cable guide 310 into a desired position. The length of the slot opening 316 of the slot 314 is such that the sidewall 320 of the single cable guide 310 can be adjusted with respect to its relative proximity with an adjacent wall (first wall 386 or second wall 388) of the cable tray 380 and maintaining a parallel relationship with the adjacent wall (first wall 386 or second wall 388) of the cable tray 380, so that the sidewall 320 may be placed adjacent either the first wall 386 or the second wall 388 of the cable tray 380, resulting in a flush arrangement with no spaces or voids between the sidewall 320 and either the adjacent first wall 386 or second wall 388. Once the single cable guide 310 is in position on the cable tray 380 desired by the user, the fastener 318 secures the single cable guide 310 in position on the cable tray 380.

As illustrated in FIGS. 14A, 14B, and 15, the cable tray 380 has a base 384 with a top surface and a bottom surface with a plurality of holes 382 positioned within the base 384, extending from the top surface to the bottom surface of the base 384. The base 384 extends to a first side portion and an opposed second side portion, wherein a first wall 386 extends upwardly from the first side portion and a second wall 388 extends upwardly from the second side portion. The first wall 386 and the second wall 388 contain an interior surface and an exterior surface. The top surface of the base 384, the interior surface of the first wall 386, and the interior surface of the second wall 388 collectively form the interior 390 of the cable tray 390. The cable tray 380 extends in the longitudinal direction to a first side edge and an opposed second side edge.

As illustrated in FIG. 15, the single cable guides (310, 310′) are placed within a cable tray 380 facing opposed directions. In other words, the single cable guide 310 faces a wall of the cable tray 380 with its base 312 and sidewall 320 in close proximity to the opposite wall of the cable tray 380. An adjacent single cable guide 310′ faces the wall opposite the wall the single cable guide 310 is facing, with its base 312′ and sidewall 320′ in close proximity to the wall the single cable guide 310 is facing. As illustrated in FIG. 14, single cable guide 310 faces the first wall 386 with its base 312 and sidewall 320 in close proximity to the second wall 388. An adjacent single cable guide 310′ faces the second wall 388 with its base 312′ and sidewall 320′ in close proximity to the first wall 386. The distance between the single cable guide 310 and an adjacent single cable guide 310′ (or a single cable guide on the second side of single cable guide 310 (not shown)) is determined by factors, such as to fit the need of the cable tray 380, the type of cable 328 inserted into the cable tray 380, the user's preference, user or regulation requirements, or preference of the installer. The distance between sets of single cable guides may also be adjusted throughout the tray system (i.e. two or more cable trays engaged together) to fit the need of the tray system or individual cable trays 380, the type of cable 328 inserted into the cable tray 380, the user's preference, user or regulation requirements, or preference of the installer.

As shown in FIGS. 14A, 14B, and. 15, a single cable guide 310 is selectively secured to the base 384 of the cable tray 380 by a fastener 318. Selectively secured means the single cable guide 310 is not integral with the cable tray 380 and may be separated from the cable tray 380 without damaging either the single cable guide 310 or the cable tray 380. The bottom portion of the base 312 of the single cable guide 310 is placed adjacent the top surface of the base 384 of the cable tray 380, with a portion of the slot opening 316 positioned “over top” or above a hole 382 within the base 384 of the cable tray 380, allowing the body of the fastener 318 to be inserted into the slot opening 316, and proceeding through the slot opening 316, and through the hole 382 within the base 384 of the cable tray 380. As illustrated, the fastener 318 is a “tubing bolt” as described above, and the bolt head is adjacent the top portion of the base 384 of the cable tray 380, the square structure below the bolt head is received within a square hole 382 on the base 384 of the cable tray 380, and the externally threaded portion of the body of the “tubing bolt” extends beyond the bottom surface of the base 384 of the cable tray 380, allowing the corresponding locking flange nut, with corresponding internal threads to the external threads of the “tubing bolt”, to be secured to the “tubing bolt” by only rotating the locking flange nut, because the “tubing bolt” will not rotate when attaching the locking flange nut since the square structure is received and retained within the square hole 382 of the base 384 of the cable tray 380. A washer may be positioned between the bottom surface of the base 384 of the cable tray 380 and the locking flange nut. While a “tubing bolt” from the James C. White Company, Inc. has been described above, a similar process can be achieved with other types of fasteners, such as a standard bolt and nut.

During the placement of cables 328 within the cable tray 380, the fastener 318 allows the single cable guide 310 to be moved in the long direction of the slot 314, allowing the single cable guide 310 to be adjusted into a desired position along the length of the slot opening 316 and positioned in close proximity or adjacent the second wall 388, creating a gap or space between second end portion of the flange 324 and the first wall 386. The gap or space allows cables 328 to be inserted or removed from the cable tray 380. The gap or space is at least slightly wider than the cable 328 being inserted into the cable tray 380, allowing the cable 328 to be inserted through the gap or space and into the interior 390 of the cable tray 380 and positioned on the base 384 of the cable tray 380, positioned on adjacent cables 328, or partially positioned on the base 384 of the cable tray 380 and partially on adjacent cables 328. The cable 328 may easily and without resistance slide around the second end portion of the flange 324 of the single cable guide 310 and the gap or space between the second end portion of the flange 324 and interior surface of the first wall 386 of the cable tray 380 is wide enough to allow the cable 328 to be inserted into the cable tray 380. The length of the slot opening 316 of the slot 314 is such that the width of the gap for cable 328 entry into the cable tray 380 may be adjusted to allow for a selected cable 328 of maximum diameter before cable 328 installation. Once the single cable guide 310 is in the desired position, the fastener 318 for the single cable guide 310 secures the single cable guide 310 in the desired position on the cable tray 380. When a fastener 318 is used, such as a “tubing bolt” available from James w. White Company, Inc. as described above, the width of the gap can be reduced or eliminated after installation of the cable 328 is complete by loosening the locking flange nut, sliding the single cable guide 310 along the base 384 of the cable tray 380, such that the gap between the second end portion of the flange 324 of the single cable guide 310 and either the first wall 386 or the second wall 388 is reduced or eliminated, by the second end portion of the flange 324 contacting either the first wall 386 or the second wall 388 of the cable tray 380, and then retightening the locking flange nut and securing the single cable guide 310 to the cable tray 380, such that the single cable guide 310 will not move within the cable tray 380 until the locking flange nut is loosened.

The cable 328 contacts a portion of the flange 324 closest to the direction the cable 328 is being inserted into the cable tray 380. As the cable 328 is pulled along the cable tray 380, the approach angle of the side portion or the angled side portion guides the cable 328 towards the second end portion of the flange 324, allowing the cable 328 to slide around the second end portion of the flange 324 and into the cable tray 380. The cable 328 then progresses to the adjacent single cable guide 310′ and the cable 328 contacts a portion of the flange 324′ closest to the direction the cable 328 is being inserted into the cable tray 380. The approach angle of the side portion or the angled side portion of single cable guide 310′ guides the cable 328 towards the second end portion of the flange 324′, allowing the cable 328 to slide around the second end portion of the flange 324′ and into the cable tray 380. Similar steps occur along the length of the cable tray 380 when the cable 328 contacts subsequent and adjacent single cable guides. The structure of the single cable guide 310 allows the cable 328 to be inserted into the cable tray 380 from either direction of the cable tray 380 because of the shape of the two side portions on either side of the flange 324 are identical and serve the same purpose and function when a cable 328 is being inserted into the cable tray 380 from either side of the single cable guide 310 or in both directions of the cable tray 380. After the cable 328 has been inserted into the cable tray 380, the single cable guides (310, 310′) are optionally moved in the long direction of the slots (314, 314′) and perpendicular to the long dimension of the cable tray 380 towards the respective wall (386, 388) closest to the second end portion of the flange (324, 324′) of the respective single cable guide (310, 310′). As shown in FIG. 14B, single cable guide 310 is optionally moved towards the first wall 386 to adjust the width of the gap for cables with a smaller diameter or to adjust the width of the gap to prevent cables from moving through the gap. During use, the single cable guide 310 may be moved towards the first wall 386 to adjust the width of the gap, so that the space or gap between the second end portion of the flange 324 and the first wall 386 has a width smaller than the width of the cables 328 intended to be inserted into the interior 390 of the cable tray 380, preventing the cables 328 from moving through this space or gap and additionally securing the cables 328 within the interior 390 of the cable tray 380. Likewise, single cable guide 310′ is optionally moved towards the second wall 388, so that the space or gap between the second end portion of the flange 324′ and the second wall 388 has a width smaller than the width of the cables 328, preventing the cables 328 from moving through this space or gap and additionally securing the cables 328 within the interior 390 of the cable tray 380. Alternatively, the second end portion of the flange 324 of the single cable guide 310 may contact the second wall 388 and the second end portion of the flange 324′ of single cable guide 310′ may also contact the first wall 386, whereby there is not a space or gap. As shown in FIG. 15, a plurality of cables 328 may be placed in the cable tray 380. Other reasons for reducing or closing the gap is for certain orientations of the cable tray 380 itself, such as vertical runs, wherein the cable tray's 380 base 384 is vertical with the horizontal plane of the horizon or floor of the building installed (i.e. the cable tray 380 is on its side), possibly curves or tray intersections (i.e. fittings), or customer preference.

While two single cable guides (310, 310′) are shown in the figures, a plurality of single cable guides may be placed along the length of the cable tray 380. Multiple cable trays 380 may be connected or engaged to each other depending upon the length of the cable tray 380 and the desired use, forming a tray system, wherein a plurality of single cable guides may be placed in each cable tray when two or more or a plurality of cable trays 380 are engaged to each other or placed within the tray system. When two or more single cable guides are used along the length of a cable tray or tray system, the single cable guides are oriented opposite each other within the interior 390 of the cable tray 380 as shown in FIGS. 14A, 14B, and 15. The base 312 of each single cable guide 310 is positioned adjacent an opposite side portion of the base 384 of the cable tray 380 adjacent an opposite wall of the cable tray 380 than each single cable guide adjacent the single cable guide 310. Each single cable guide 310 may optionally face in an opposite direction than the direction the adjacent single cable guide 310′ is facing. In other words, the sidewall 320 of a single cable guide 310 is in close proximity to the second wall 388 of the cable tray 380, and the sidewall 320′ of an adjacent single cable guide 310′ (or each adjacent single cable guide if there is a single cable guide positioned on a first side of the single cable guide 310 and the second side of the single cable guide 310. As illustrated in FIGS. 14A, 14B, and 15, the single cable guide 310 has an adjacent single cable guide 310′ on its first side) is adjacent the first wall 386 of the cable tray 380.

While the single cable guides (310, 310′) as illustrated as facing in opposite directions, the single cable guides (310, 310′) may optionally face the same direction, depending upon the desired use and desires of the user. In other words, the sidewall 320 of a single cable guide 310 is in close proximity to the second wall 388 of the cable tray 380, and the sidewall 320′ of an adjacent single cable guide 310′ (or each adjacent single cable guide if there is a single cable guide positioned on a first side the single cable guide 310 and the second side of the single cable guide 310. As illustrated in FIGS. 14A, 14B, and 15, the single cable guide 310 has an adjacent single cable guide 310′ on its first side) is also adjacent the second wall 388 of the cable tray 380. In curved cable trays or curved tray connectors, the single cable guides (310, 310′) may face the same direction.

Single cable guides (310, 310′) are preferably used in pairs and positioned fairly close to each other on the cable tray 380, because the single cable guides (310, 310′) function together and cables 328 within the cable tray 380 cannot easily escape the cable tray 380 after the cables are installed even when the gap between the flange (324, 324′) and the first wall 386 or the second wall 388 is at its maximum and the single cable guides (310, 310′) have not been moved to close or reduce the width of the gap.

While the single cable guides (310, 310′) in this embodiment are illustrated as inserted into the interior 390 of the cable tray 380, the single cable guides (310, 310′) may also be slid over the exterior surface of the cable tray 310 as shown in FIGS. 7 and 8 and described above.

The single cable guide 310 may be enclosed within a kit, whereby one or more single cable guides 310, along with one of more fasteners 318, are sold together as a kit. For example, each kit could be composed of two single cable guides (310, 310′) and two fasteners (318, 318′), such as two “tubing bolts” and two locking flange nuts or two bolts and two nuts. Alternatively, each kit could be composed of a plurality of single cable guides (310, 310′) and a plurality of fasteners (318, 318′), such as a plurality of “tubing bolts” and a plurality of locking flange nuts or a plurality of bolts and a plurality of nuts, wherein the number of fasteners (318, 318′) correspond to the number of single cable guides (310, 310′). In other words, each kit contains an equal number of single cable guides (310, 310′) and fasteners (318, 318′). For example, a kit that contains two single cable guides (310, 310′) will contain a corresponding number of fasteners (318, 318′)-two. The kit will preferably contain an even number of single cable guides (310, 310′) and fasteners (318, 318′). The single cable guides (310, 310′) are preferably intended to be utilized in pairs or sets of two that are spaced-apart from each other on a cable tray 380, facing in opposite directions or oriented towards opposing walls (first wall 386 or second wall 388) of the cable tray 380, to allow for a variety of cables 328 to be inserted into the cable tray 380 or installed in differing applications. The kit may include a container to hold or house the single cable guide and fastener that comprises the kit, including two or more single cable guides or a plurality of single cable guides and two or more fasteners or a plurality of fasteners. The container may be a bag, such as a plastic bag, a drawstring bag, or the like. Alternatively, the container may be a box, housing or the like. The single cable guide and fastener are contained within the container for storage, shipping, retaining the single cable guide and fastener in the same location, and/or packaging.

What is claimed is:

1. A cable guide for use with a cable tray, the cable guide comprising:
(a) a base having a top portion, a bottom portion, a first end portion, a second end portion, two side portions parallel to each other, and a longitudinal axis, the two side portions extend longitudinally in a first direction along the longitudinal axis, the first end portion is opposite the second end portion in the first direction and the two side portions extend between the first end portion to the second end portion, the first end portion is perpendicular to the two side portions and the second end portion has an arcuate shape extending from one side portion to the opposed side portion;
(b) a slot is disposed within the base, the slot contains a pair of sides opposed to each other and a pair of opposed end portions, wherein the opposed end portions are in a perpendicular relationship with the pair of sides and the sides intersect the end portions defining corners, the slot includes a slot opening extending from the top portion to the bottom portion of the base;
(c) a sidewall extending upwardly from the first end portion of the base to an upper end; and
(d) a flange extends outwardly from the upper end of the sidewall and parallel to the base having a top portion, a bottom portion, a first end portion, a second end portion, a first side portion, and a second side portion opposite the first side portion.

2. The cable guide of claim 1, further comprising a fastener to fasten the cable guide to the cable tray.

3. The cable guide of claim 1, wherein the cable guide further comprises a fastener dimensioned to fit into the slot opening of the slot in the base of the cable guide, to fasten the base to the cable tray.

4. The cable guide of claim 1, wherein the length of the flange is greater than the length of the base.

5. The cable guide of claim 1, wherein the flange has a longitudinal axis with a first direction, the first side portion and the second side portion of the flange extend in the first direction from the first end portion and the width between the first side portion and the second side portion is constant for a predetermined distance, thereafter the first side portion and the second side portion converge toward the longitudinal axis.

6. The cable guide of claim 1, wherein the second end portion of the flange is curved.

7. The cable guide of claim 1, wherein the sidewall is generally perpendicular to the base and contains two opposed side portions extending along the length of the sidewall and the width of the sidewall is constant along its length.

8. The cable guide of claim 1, wherein the flange is flexible.

9. A method of retaining cables within a cable tray with a cable guide, comprising:
providing a cable tray, comprising:
a base with a top surface and a bottom surface that extends to a first side portion and an opposed side portion, a first wall extends upwardly from the first side portion and a second wall extends upwardly from the second side portion, the first wall and the second wall have an interior surface and an exterior surface, the top surface of the base, interior surface of the first wall, and interior surface of the second wall collectively define an interior of the cable tray, a plurality of holes are positioned within the base;
providing at least one cable guide comprising:
(a) a base having a top portion, a bottom portion, a first end portion, a second end portion, two side portions parallel to each other, and a longitudinal axis, the two side portions extend longitudinally in a first direction along the longitudinal axis, the first end portion is opposite the second end portion in the first direction and the two side portions extend between the first end portion to the second end portion, the first end portion is perpendicular to the two side portions and the second end portion has an arcuate shape extending from one side portion to the opposed side portion;
(b) a slot is disposed within the base, the slot contains a pair of sides opposed to each other and a pair of opposed end portions, wherein the opposed end portions are in a perpendicular relationship with the pair of sides and the sides intersect the end portions defining corners, the slot includes a slot opening extending from the top portion to the bottom portion of the base and having a long direction;
(c) a sidewall extending upwardly from the first end portion of the base to an upper end; and
(d) a flange extends outwardly from the upper end of the sidewall and parallel to the base having a top portion, a bottom portion, a first end portion, a second end portion, a first side portion, and a second side portion opposite the first side portion;
providing a fastener to fasten the cable guide to the cable tray placing the bottom portion of the base of the cable guide adjacent the top surface of the base of the cable tray such that the slot opening of the base of the cable guide is adjacent a hole within the base of the cable tray;
inserting the fastener into the slot opening and the hole for fastening the cable guide to the cable tray and allowing the cable guide to move axially within the cable tray;
positing the cable guide along the base of the cable tray such that there is a gap between the second end portion of the flange and either the first wall or the second wall, whereby the gap has a width greater than the width of a cable intended to be inserted within the interior of the cable tray; and
inserting a cable within the interior of the cable tray.

10. The method of retaining cables within a cable tray with a cable guide of claim 9, wherein the fastener is a low head fastener.

11. The method of retaining cables within a cable tray with a cable guide of claim 9, wherein the length of the flange is greater than the length of the base.

12. The method of retaining cables within a cable tray with a cable guide of claim 9, wherein the flange has a longitudinal axis with a first direction, the first side portion and the second side portion of the flange extend in the first direction from the first end portion and the width between the first side portion and the second side portion is constant for a predetermined distance, thereafter the first side portion and the second side portion converge toward the longitudinal axis.

13. The method of retaining cables within a cable tray with a cable guide of claim 9, further comprising moving the cable guide along the base of the cable tray such that the gap between the second end portion of the flange and either the first wall or the second wall is less than the width of the cable inserted into the interior of the cable tray.

14. The method of retaining cables within a cable tray with a cable guide of claim 9, wherein the sidewall of the cable guide is generally perpendicular to the base of the cable guide and contains two opposed side portions extending along the length of the sidewall and the width of the sidewall is constant along its length.

15. The method of retaining cables within a cable tray with a cable guide of claim 9, wherein the flange of the cable guide is flexible.

16. A kit for retaining cables, comprising:
(a) a cable guide, comprising:
(i) a base having a top portion, a bottom portion, a first end portion, a second end portion, two side portions parallel to each other, and a longitudinal axis, the two side portions extend longitudinally in a first direction along the longitudinal axis, the first end portion is opposite the second end portion in the first direction and the two side portions extend between the first end portion to the second end portion, the first end portion is perpendicular to the two side portions and the second end portion has an arcuate shape extending from one side portion to the opposed side portion;
(ii) a slot is disposed within the base, the slot contains a pair of sides opposed to each other and a pair of opposed end portions, wherein the opposed end portions are in a perpendicular relationship with the pair of sides and the sides intersect the end portions defining corners, the slot includes a slot opening extending from the top portion to the bottom portion of the base;
(iii) a sidewall extending upwardly from the first end portion of the base to an upper end;
(iv) a flange extends outwardly from the upper end of the sidewall and parallel to the base having a top portion, a bottom portion, a first end portion, a second end portion, a first side portion, and a second side portion opposite the first side portion; and
(b) a fastener to fasten the cable guide to a cable tray.

17. The kit for retaining cables within a cable tray of claim 16, wherein the fastener is dimensioned to fit into the slot opening of the slot in the base of the cable guide to fasten the cable guide to the cable tray.

18. The kit for retaining cables within a cable tray of claim 16, wherein the length of the flange is greater than the length of the base.

19. The kit for retaining cables within a cable tray of claim 16, wherein the flange has a longitudinal axis with a first direction, the first side portion and the second side portion of the flange extend in the first direction from the first end portion and the width between the first side portion and the second side portion is constant for a predetermined distance, thereafter the first side portion and the second side portion converge toward the longitudinal axis.

20. The kit for retaining cables within a cable tray of claim 16, wherein the flange is flexible.
